(19) United States
(12) Patent Application Publication
(10) Pub. No.: US 2017/0169516 A1
(43) Pub. Date: Jun. 15, 2017

(54) Methods and systems for automatic generation of media(s) from financial/corporate information

(71) Applicant: Amigobulls Inc., Palo Alto, CA (US)

(72) Inventors: Chandrashekhar Arwind Sohoni, Bangalore (IN); Mandeep Makkar, Bangalore (IN); Harish Kumar, Thirupur(DT) (IN); Kumar Abhishek, Patna (IN)

(73) Assignee: Amigobulls Inc., Palo Alto, CA (US)

(21) Appl. No.: 15/272,842

(22) Filed: Sep. 22, 2016

Related U.S. Application Data
(60) Provisional application No. 62/221,635, filed on Sep. 22, 2015.

(51) Int. Cl. G06Q 40/06

(52) U.S. Cl. CPC G06Q 40/06

(57) ABSTRACT

Methods and systems for automatically analyzing financial/corporate information and reporting it in form of media. Embodiments disclosed herein relate to analysis and reporting of financial performance and related items and more particularly to analysis and reporting of financial performance and related items of portfolio(s)/organization(s) in the form of media.

### CROSS REFERENCE TO RELATED APPLICATIONS

This application is based on and derives the benefit of U.S. Provisional Application 62/221,635, filed on Sep. 22, 2015, the contents of which are incorporated herein by reference.

### TECHNICAL FIELD

Embodiments disclosed herein relate to analysis and reporting of financial performance and related items and more particularly to analysis and reporting of financial performance and related items of portfolio(s)/organization(s) using media.

### BACKGROUND

In a first scenario, financial analysis plays an important role in assessing an organization's performance. The financial analysis helps in identifying relationship between key numbers that define the organization's performance, which in turn can be compared with industry standards. The performance of the organization in terms of sales, and profits in each quarter can be compared, to verify if the organization's performance is meeting expected levels, and is heading in the intended direction.

Financial analysis can be done manually, wherein a person needs assess the organization's performance parameters by manually analyzing financial statements. However, this can turn out to be a cumbersome process, depending on size of the organization in terms of business and strength. In order to automate the process of financial analysis, certain systems are currently being used in the market. These systems are capable of collecting financial data of an organization as input, analyze the data using a suitable data processing algorithm, and generate a text analysis that represents the performance of the organization.

In a second scenario, users have financial portfolios, comprising of at least one of stocks, mutual funds, reality, cash investments, and so on. Managing and tracking the performance of these portfolios can be cumbersome for a user. The user can perform these tasks manually, wherein the user checks the value of the portfolio element(s) individually and tracks the value of the portfolio over time manually.

There are services, which enable users to track their portfolios. These services enable the users to view the performance of their portfolios online or offline. For example, the service can enable the user to view the portfolio in a tabular format online. In another example, the service can enable the user to download the details of the portfolio in a file format such as PDF (Portable Document Format), Excel, CSV (Comma Separated Values), and so on. The user can then view and analyze the portfolio.

However, the text analysis is not easy to read and comprehend, and may not give the right perspective to the people who are reviewing the data. However, the user may find the presented information difficult to understand. The user has to have some level of background knowledge of terms used, to enable the user to understand the information.

### BRIEF DESCRIPTION OF FIGURES

Embodiments herein are illustrated in the accompanying drawings, through out which like reference letters indicate corresponding parts in the various figures. The embodiments herein will be better understood from the following description with reference to the drawings, in which:

FIG. 1 depicts a system for creating and providing information related to at least one portfolio of a user and/or information related to an organization in a media format, according to embodiments as disclosed herein;

FIG. 2 depicts a media analysis module, according to embodiments as disclosed herein;

FIGS. 3a, 3b, 3c, 3d and 3e depict example screenshots of a generated video for a portfolio, according to embodiments as disclosed herein;

FIGS. 4a, 4b and 4c depict flowcharts depicting the process for analyzing and reporting information related to at least one portfolio of a user in a media format to the user, according to embodiments as disclosed herein;

FIG. 5 is a flow diagram which shows steps involved in the process of performing financial analysis using the media analysis module, as disclosed in the embodiments herein;

FIG. 6 illustrates a plurality of components of a media analysis engine for analyzing and reporting information related to at least one portfolio of a user in a media format to the user, according to embodiments as disclosed herein; and

FIGS. 7a-7k depict example screenshots of a generated video for financial data of an organization, according to embodiments as disclosed herein.

### DETAILED DESCRIPTION

The embodiments herein and the various features and advantageous details thereof are explained more fully with reference to the non-limiting embodiments that are illustrated in the accompanying drawings and detailed in the following description. Descriptions of well-known components and processing techniques are omitted so as to not unnecessarily obscure the embodiments herein. The examples used herein are intended merely to facilitate an understanding of ways in which the embodiments herein may be practiced and to further enable those of skill in the art to practice the embodiments herein. Accordingly, the examples should not be construed as limiting the scope of the embodiments herein.

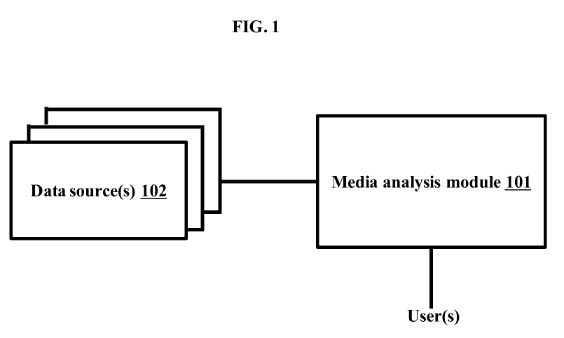

The embodiments herein disclose methods and systems for analyzing and reporting information related to at least one of a user and/or an organization in a media format, wherein the presented information relates to at least one of financial performance of the organization(s), or financial performance of at least one portfolio of the user. Referring now to the drawings, and more particularly to FIGS. 1 through 7, where similar reference characters denote corresponding features consistently throughout the figures, there are shown preferred embodiments.

### Definitions:

User herein refers to a user/firm/entity who has or has access to at least one portfolio. The user can be an investor, or authorized to access at least one portfolio belonging to another user/firm/entity.

Organization herein refers to an organization such as a company, mutual fund, and so on, whose financial information and other associated information (such as news articles) is of interest.

The portfolio as referred to herein can comprise of at least one of stocks, mutual funds, reality, cash investments, bonds, deposits, funds, equities, and so on. Updates to the portfolio can refer to changes to the portfolio within a pre-defined time period, wherein the time period can be at least one of a default time period; and/or a user defined time period.

Media herein refers to data comprising at least one of audio, video, graphical information, and text. For example, the media can be a video displaying the data related to the portfolio (such as a summary) to the user, wherein the video comprises of at least one of graphical information, text and an audio commentary. In another example, the media can be a pure audio commentary of the data related to the portfolio.

### Description:

FIG. 1 depicts a system for creating and providing information related to at least one portfolio of a user and/or information related to an organization in a media format. The media analysis module 101 is connected to at least one data source 102. The data source 102 can be at least one of a database, a server (such as a file server, data server), the cloud, and so on. The data source 102 can comprise of information related to the portfolio of the user, such as authentication details of the user, contact details of the user, components/elements of the portfolio(s), daily prices of stocks/equities, daily volumes of stocks/equities, financial statements of organizations related to the portfolio (if any), ratings/scores of elements present in the portfolio (such as organizations whose stocks are present in the portfolio), opinions/news/forecasts about elements present in the portfolio, and so on. The data source 102 can also comprise of data related to the organization, such as financial figures, costs, balance sheets, profit and loss statements, cash flow statements, and so on. The data source 102 can fetch information such as daily prices of stocks/equities, financial statements of organizations related to the portfolio (if any), ratings/scores of elements present in the portfolio (such as organizations whose stocks are present in the portfolio), opinions/news/forecasts about elements present in the portfolio, and so on, from one or more locations that the data source 102 can access. Consider an example that the data source 102 is a database, wherein the data can be stored in files/DBMS (Database Management Systems). The data may be in at least one of a suitable format, such as text, tabular, image, and/or graphical format.

The media analysis module 101 can fetch data from the data source 102 and/or any other source of data. The media analysis module 101 can decide on what data has to be presented in the media. The media analysis module 101 can add graphical information, audio, and/or animations to the media. The media analysis module 101 can generate the media. The media analysis module 101 can enable the user to access the media. The media analysis module 101 can also store the generated media in a pre-defined location.

The media analysis module 101 may be configured to collect financial data of at least one organization as input for performing the financial analysis. For example, a softcopy of a document that contain financial data may be uploaded to the media analysis module 101, using a suitable interface provided to the user. In another example, data may be manually entered to the media analysis module 101 1, using at least one input device/interface such as a keyboard, touch screen and so on. In another example, the media analysis module 101 can be configured to collect/fetch automatically, the data required to perform financial analysis of at least one organization, from at least one data source/database connected to the media analysis module 101. The media analysis module 101 can be configured to process the collected input(s), and identify parameters that represent performance of the organization in terms of financial aspects. The media analysis module 101 can be further configured to process the identified parameters further and identify relationship between selected parameters. The media analysis module 101 may be further configured to generate at least one script, based on the identified parameters, value of parameters, and relationship between the parameters; wherein the script can be in at least one suitable format, such as audio, video, graph. The media analysis module 101 is further configured to generate at least one media that illustrates performance of the organization in terms of financial analysis, based on the scripts generated.

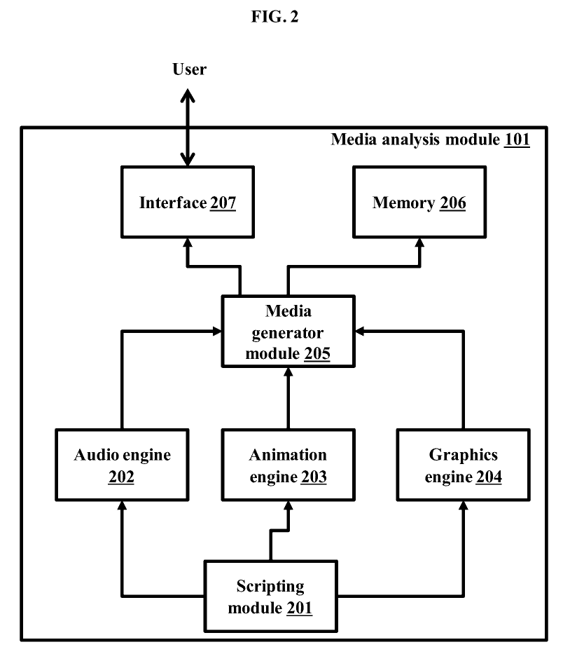

FIG. 2 depicts a media analysis module. The media analysis module 101 as depicted comprises of a scripting module 201, an audio engine 202, an animation engine 203, a graphics engine 204, a media generator module 205, a memory 206, and an interface 207. The memory 206 can be at least one of a remotely located memory (such as a file server, a data server, the cloud, and so on), and a local memory. The interface 207 enables the user to provide data to the media analysis module 101, such as setting at least one option related to the generated media (such as setting the time period, the mode of sharing the generated media, and so on). The interface 207 can enable the user to access the media.

The scripting module 201 can decide the components of the media. The scripting module 201 can fetch the data from the data source 102. The scripting module 201 can also fetch data from other sources, as required. The scripting module 201 can analyze the data and determine what data should be present in the media. The scripting module 201 can also determine the flow of data and the order in which data has to be presented in the media. The scripting module 201 can consider the options, as set by the user or any other authorized person (such as an administrator), while determining the flow and order of the data. For example, the user can set options that a summary has to be presented first, followed by a detailed analysis of the updates to the portfolio. The scripting module 201 can also determine which graphics to be displayed, what text to be converted as speech, animations to be added to the media, and so on.

Consider that the data fetched relates to a portfolio belonging to a user, the scripting module 201 can query the data source 101 and determine the updates to the portfolio(s) of the user. If there is at least one update to the portfolio, the scripting module 201 can consider the portfolio for further analysis. If there are no updates, the scripting module 201 can use the last generated media for that portfolio.

In an example, consider that the portfolio comprises of at least one stock of at least one organization and there are updates to the organization, the scripting module 201 can determine if the portfolio needs to be analyzed based on factors such as the market capital of the company(ies), last traded date(s) and availability of financials for a pre-defined financial time period (for example, financials for the previous four quarters, financials for the previous two quarters, and so on). The scripting module 201 can query the financial statements and price data for the companies and calculate a plurality of financial ratios for the organization such as operating margin, debt equity, return of equity, free cash flow margin, price to earnings ratio and so on. The financial ratios are calculated using suitable formulae. In an example, PE (Price-Earnings) Ratio can be calculated as (Price)/(Last 4 Quarters EPS Diluted). For some of the ratios, however, adjustments can be made to the formulae to reflect the attributes that can be considered as important for the stocks to perform well. For example, if the PE ratio needs to be adjusted for one-time gains or losses, the formula can be (Price)/(Last 4 Quarters EPS before non-recurring items). The scripting module 201 can compare the plurality of computed financial ratios to a corresponding pre-computed industry average of the financial averages. The scripting module 201 can calculate the median value for each of the ratios by taking all the ratios for all the companies in the industry. Based on the comparison, the scripting module 201 can determine a set of attributes, which can be used to calculate a score. The scripting module 201 can determine the attributes based on previous data. The scripting module can consider data from a previous time period (such as 5 years, 10 years, and so on) and run the model with various combinations of attributes to arrive at the key attributes to be displayed in the media. The scripting module 201 can then calculate the scores for all companies in the portfolio by assigning appropriate weightages to the attributes. The scripting module 201 can assign the weightages to the attributes based on observations about the industry data and the effect of that attribute on the performance of the companies in that industry. The scripting module 201 can then assign scores to each of the attribute based on the deciles that they fall into. A decile is a value that divides the sorted data into ten equal parts, so that each part represents 1/10 of the sample or universe. For example: If there are 100 companies in the sample, and the 10th organization value is 10%, 20th organization value is 20%, 30th organization value is 30% and so on, if APPL's value is 82%, then it gets a score of 9. The scripting module 201 then calculates the weighted average of the attributes to arrive at the final score for the organization. For example, consider that an attribute “Price to Earnings Ratio” has 5.25% weightage. The scripting module 201 can consider a set of pre-defined rules and overlay the rules with weightage and financial ratio value to decide the pros and cons about the stock/organization. Rules are a set of logical conditions that are defined for the different attributes. For example: A rule could be “If PE score is less than 3, then it is a con”. The scripting module 201 can run data across these rules to figure out applicable pros and cons. The scripting module 201 can compare the overlaid rules with the industry average. For example: A pro could be “Yum Brands' average operating margin of 16.1% was exceptional” because the industry average was only 3%. However, YUM brands revenue growth was 3%, which is in line with industry average of 3.5%. So the scripting module 201 does not consider it good enough to be mentioned as pro or con. An example of con could be “The YUM stock currently trades at a PE of 26.9, which is expensive, compared to the industry average of 19.6.” The scripting module 201 can use the pros and cons as the base for the video. The scripting module 201 can determine a sequence of data to show based on pre-defined order. For example, “1. Price Section 2. Profit & Loss related Section 3. Cash-Flow Section etc.” Based on pre-defined rules, the scripting module 201 can decide the kind of visuals should be shown for each of the data. For example: “Price Section” can be displayed as text visual whereas the profit & loss section can be displayed as a graph/chart. The scripting module 201 can convert the pros and cons to visual templates that contains layout of text and graphics, which is then used to generate appropriate graphics. There are predefined rules set for each of the pros and cons that are generated. The scripting module 201 applies these rules and determines if a particular pro/con should be represented as a chart or text. These rules are based on user behavior and consumption of the media. For example, the scripting module 201 can display the “Price Section” in a graph format, whereas “Dividend” or “Dividend Yield” can be displayed as text. The scripting module 201 can convert the pros and cons to human-understandable text that is taken by the text to audio engine 202 to produce audio. The scripting module 201 can perform the conversion based on pre-defined rules that determine what kind of text will sound better for telling a certain pro or con. The scripting module 201 can generate numbers along with each pro con, but the user may not want to hear all those numbers. So, the scripting module 201 can determine the important numbers that the user will like to hear or are more relevant for the user and how should it sound. Based on these rules, the scripting module 201 can convert the pros and cons to human understandable text. For example, if the PE is 3.7% below the industry average, the scripting module 201 can avoid saying an “odd-sounding” value by rounding the values.

The audio engine 202 can fetch input text from the scripting module 201. The audio engine 202 can convert the fetched text to speech. The audio engine 202 can support text to speech conversion in various languages like English, Spanish, Hindi, French, Tamil, Gujarati, and so on. The audio engine 202 can also generate audio in a plurality of voice types and/or genders.

The animation engine 203 can create animations and other effects, based on the inputs from the scripting module 201. The animations can vary based on factors such as type of media, data present in the media, and so on. The animation engine 203 can perform animations/effects such as splitting the text, rotating objects, flipping objects, fade-in, fade-out, zoom-in, zoom-out and so on.

The graphics engine 204 can generate graphics (such as charts) that will be shown in the media. The graphics engine 204 can fetch the input from the scripting module 201 and generate charts. Based on inputs received from the scripting module 201, the graphics engine 204 can determine the kind of chart that has to be generated for each pro/con. The graphics engine 204 can then create these charts based on data and the type of chart as inputs.

The media generator module 205 can stitch together the components such as the audio, charts, script and animation received from the other modules and generates the media. The media generator module 205 can create a media (such as a video) using a suitable means, by using the charts, text templates and audio as inputs. The media generator module 205 can also make the media compatible with multiple devices and/or channels. The media generator module 205 can add functionalities corresponding to such as play, pause, seek, zoom out/in, stop, and so on.

The scripting module 201 may be configured to process the financial data collected as input, based on at least one pre-defined parameter, and fetch at least one value that represents stock and rating of the organization. The scripting module 201 can convert the values to a format (preferably text format) that any user can understand, such that the ratings and any related performance details can be conveyed to the user, i.e., the script may be at least one template of sentence that is generated from the input data. An example of a script is “Revenue grew by 5% in last 10 years”. The graphics engine 204 can be used for creating text/images that match data generated by the scripting module 201. The graphics engine 204 can be configured to create at least one chart corresponding to the data generated by the scripting module 201. The audio engine 202 can be configured to convert the human understandable text data to corresponding audio data. The media generator module 205 can be configured to collect and process the data from the audio engine 202, the animation engine 203 and the graphics engine 204 to generate media, wherein the media represents the financial aspects of the organization.

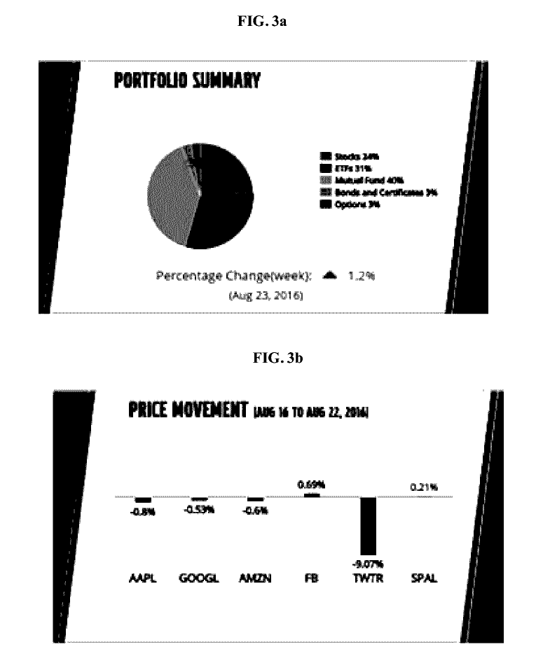

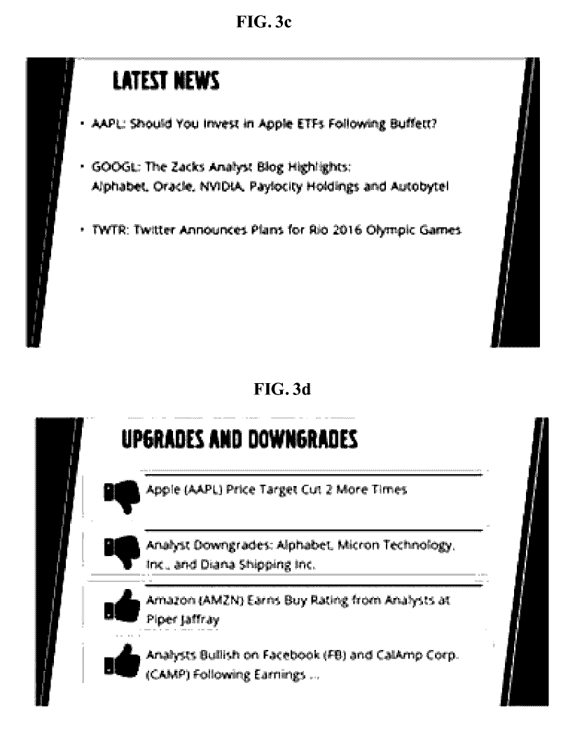

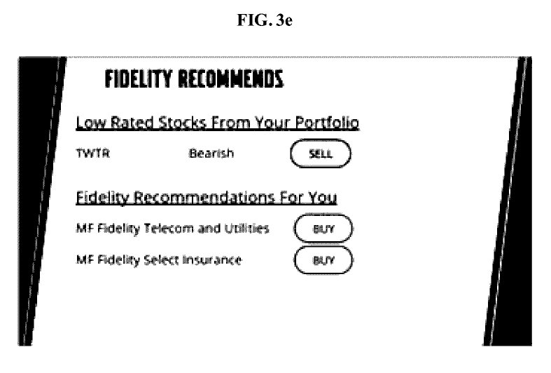

Example screenshots of a generated video can be seen in FIGS. 3a, 3b, 3c, 3d and 3e. In the example herein, FIG. 3a depicts a summary of the portfolio. FIG. 3b depicts the movement of prices of elements of the portfolio over time. FIG. 3c depicts a selection of news related to the companies whose stocks are present in the portfolio. FIGS. 3d and 3e depict the recommendations from analysts. The generated media can be of a format that can play seamlessly on all devices. The media generator module 205 can also make the media interactive. For example, a user can click a link from within the media and open up another URL to read more or do some actionable like calling another, sending a message, and so on. The media generator module 205 can also store the generated media in a suitable location such as the memory 206.

For example, a sample portfolio of a user may comprise of stocks (24%), Exchange traded mutual funds (31%), mutual funds (40%), bonds (3%) and options (3%). Given these inputs, the media analysis module 201 queries the data storage and comes up with a set of attributes that should be shown in the video such as % price change from the time of investment and the latest portfolio value. The media analysis module 201 also determines the values of the attributes such as the latest portfolio value. The media analysis module 201 then decides as to what graphics should be shown for what section. For example, portfolio split can be represented as a pie chart. The media analysis module 201 then creates charts for each chart section. The media analysis module 201 also creates a corresponding human understandable text for each section. The media analysis module 201 then converts the text to come up with a good audio for each section. The media analysis module 201 joins the audio, chart and animation to create the video.

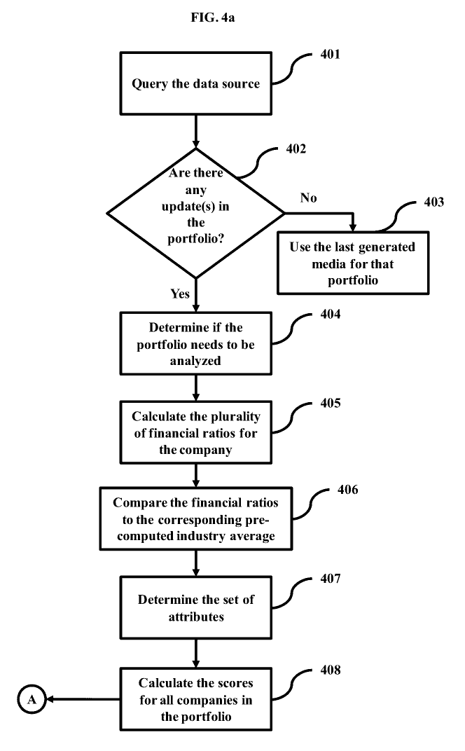

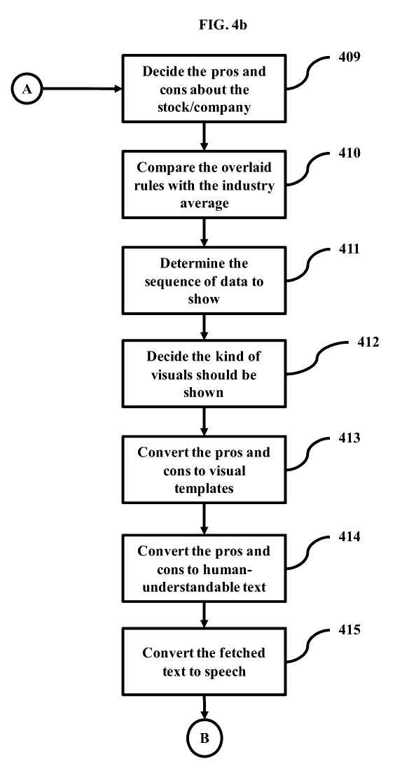

FIGS. 4a, 4b and 4c depict flowcharts depicting the process for analyzing and reporting information related to at least one portfolio of a user in a media format to the user. The media analysis module 101 queries (401) the data source 101 and checks (402) if there are any updates to the portfolio(s) of the user. If there are no updates, the media analysis module 101 uses (403) the last generated media for that portfolio. If there any updates, the media analysis module 101 determines (404) if the portfolio needs to be analyzed based on factors such as the market capital of the company(ies), last traded date(s) and availability of financials for a pre-defined financial time period. The media analysis module 101 calculates (405) the plurality of financial ratios for the organization such as operating margin, debt equity, return of equity, free cash flow margin, price to earnings ratio and so on, by querying the financial statements and price data for the companies. The media analysis module 101 compares (406) the plurality of computed financial ratios to the corresponding pre-computed industry average of the financial ratios. Based on the comparison, the media analysis module 101 determines (407) the set of attributes. The media analysis module 101 calculates (408) the scores for all companies in the portfolio by assigning appropriate weightages to the attributes. The media analysis module 101 decides (409) the pros and cons about the stock/organization by overlaying the rules with weightage and financial ratio value. The media analysis module 101 compares (410) the overlaid rules with the industry average. The media analysis module 101 determines (411) the sequence of data to show based on pre-defined order. Based on pre-defined rules, the media analysis module 101 decides (412) the kind of visuals should be shown for each of the data. The media analysis module 101 converts (413) the pros and cons to visual templates that contain layouts of text and graphics. The media analysis module 101 converts (414) the pros and cons to human-understandable text that can be used to produce audio. The media analysis module 101 then converts (415) the fetched text to speech. The media analysis module 101 generates (416) graphics that will be shown in the media. The media analysis module 101 creates (417) animations and effects. The media analysis module 101 generates (418) the media by stitching together the components such as the audio, charts, script and animation received from the other modules and makes (419) the generated media available to the user. The media analysis module 101 can make the media available to the user by at least one of enabling the user to access the media, storing the media in a suitable location. The various actions in method 400 may be performed in the order presented, in a different order or simultaneously. Further, in some embodiments, some actions listed in FIGS. 4a, 4b and 4c may be omitted.

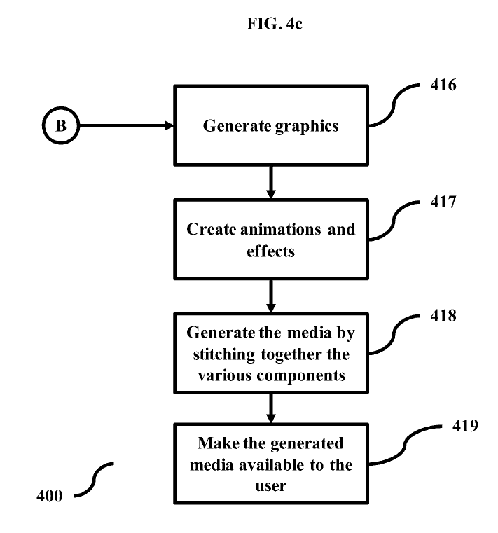

FIG. 5 is a flow diagram, which shows steps involved in the process of performing financial analysis using the media analysis module. The media analysis module 101 is configured to collect (501) at least one financial data as input. The media analysis module 101 further converts (502) the input data to corresponding scripts, wherein the script may contain a series of text, images or animation. The media analysis module 101 can be configured to generate the script by creating and analyzing financial statements from the input data collected. While analyzing the financial statements, the media analysis module 101 creates at least one of a ratio, growth rate, and a profitability indicator. For example, the ratio may be a liquidity ratio, debt equity ratio, or an interest coverage ratio. Examples of the growth rate are revenue growth, and net income growth; which may be calculated for different time periods (such as on yearly, quarterly, or monthly basis). Examples of profitability indicators are operating profit margin, net profit margin, return on equity, and return on invested capital. Further, based on the ratio, growth rate, and profitability indicator, the media analysis module 101 calculates industry averages, and identifies rating of the organization by comparing the organization specific rating with the industry average; wherein the industry averages of companies of the same type are considered for identifying rating of the organization. For example, if the organization for which the financial analysis is being done is providing interne search engine services, then the industry averages of companies such as but not limited to Google, and Yahoo can be considered to identify rating of the organization, as Google and Yahoo also own search engines. By processing the data generated during the analysis stage, the media analysis module 101 generates (503) media that illustrates performance of the organization. The various actions in method 500 may be performed in the order presented, in a different order or simultaneously. Further, in some embodiments, some actions listed in FIG. 5 may be omitted.

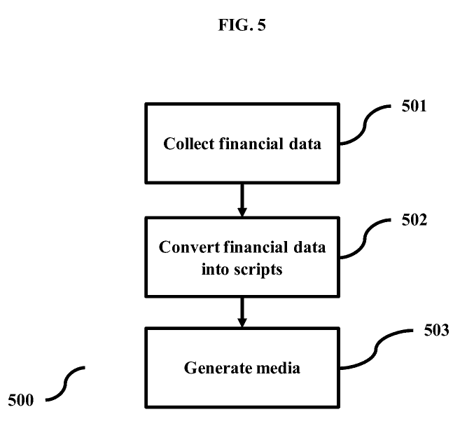

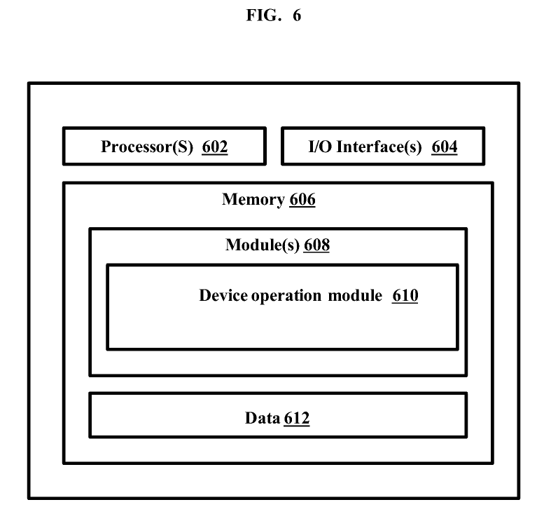

FIG. 6 illustrates a plurality of components of a media analysis engine for analyzing and reporting information related to at least one portfolio of a user in a media format to the user. Referring to FIG. 6, the media analysis engine 101 is illustrated in accordance with an embodiment of the present subject matter. In an embodiment, media analysis engine 101 may include at least one processor 602, an input/output (I/O) interface 604 (herein a configurable user interface), and a memory 606. The at least one processor 602 may be implemented as one or more microprocessors, microcomputers, microcontrollers, digital signal processors, central processing units, state machines, logic circuitries, and/or any devices that manipulate signals based on operational instructions. Among other capabilities, the at least one processor 602 is configured to fetch and execute computer-readable instructions stored in the memory 606.

The I/O interface 104 may include a variety of software and hardware interfaces, for example, a web interface, a graphical user interface such as a display screen, a camera interface for the camera sensor (such as the back camera and the front camera on the media analysis engine 101), and the like.

The I/O interface 604 may allow the media analysis engine 101 to communicate with other devices. The I/O interface 604 may facilitate multiple communications within a wide variety of networks and protocol types, including wired networks, for example, Local Area network (LAN), cable, etc., and wireless networks, such as Wireless LAN, cellular, Device to Device (D2D) communication network, Wi-Fi networks and so on. The modules 608 include routines, programs, objects, components, data structures, and so on, which perform particular tasks, functions or implement particular abstract data types. In one implementation, the modules 608 may include a device operation module 610. The device operation module 610 can be configured to allow the user to handle one or more tasks of the application such as entering options related to the functions of the media analysis engine 101, such as setting the time period for the update, the mode of communication of the update, and so on. The device operation module can be configured to execute one or more tasks corresponding to the application on the media analysis engine 101 in accordance with embodiments as disclosed herein.

The modules 608 may include programs or coded instructions that supplement applications and functions of the media analysis engine 101. The data 612, amongst other things, serves as a repository for storing data processed, received, and generated by one or more of the modules 608. Further, the names of the other components and modules of the media analysis engine 101 are illustrative and need not be construed as a limitation.

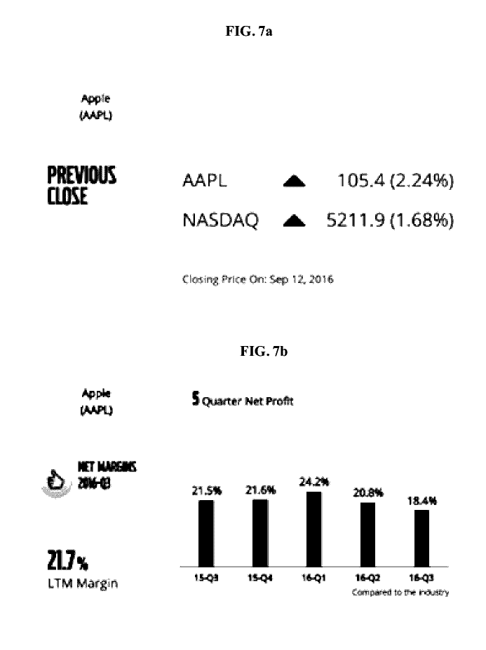

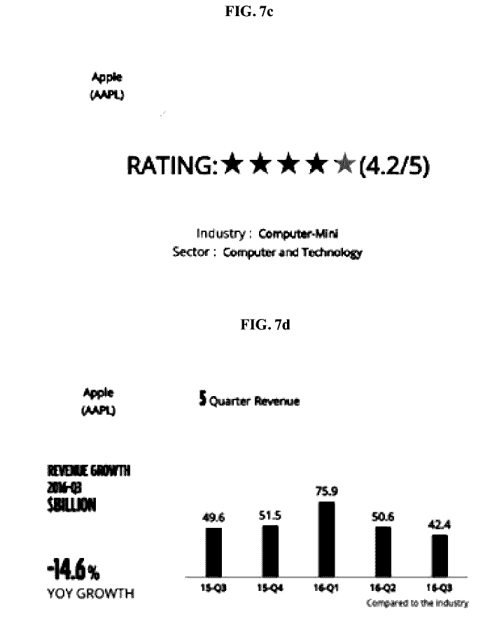

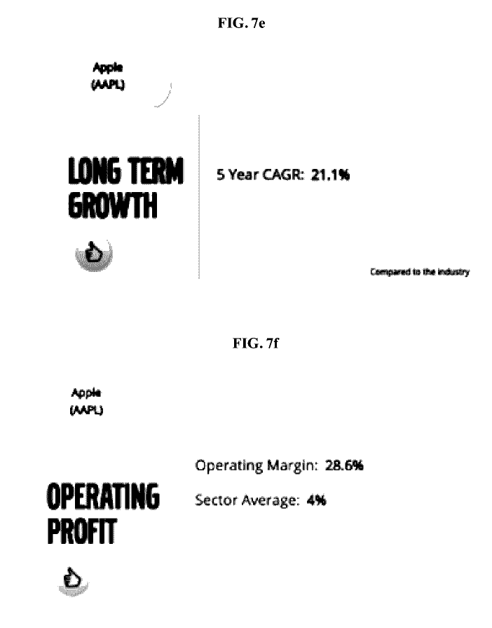

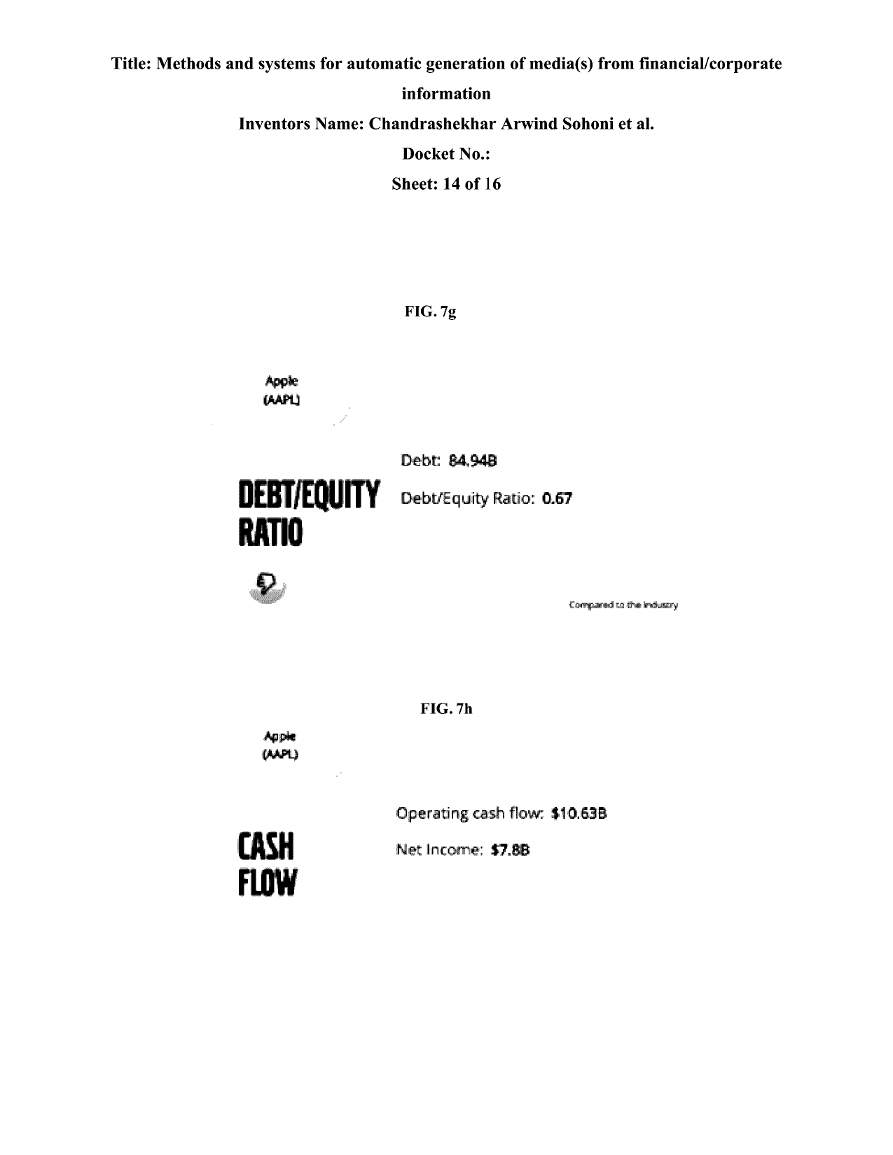

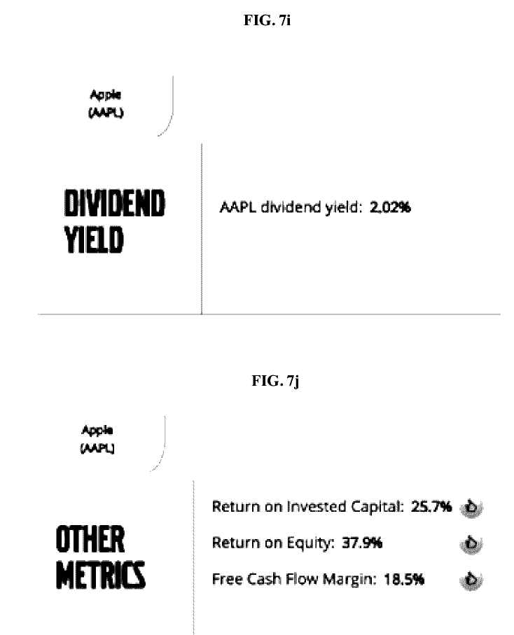

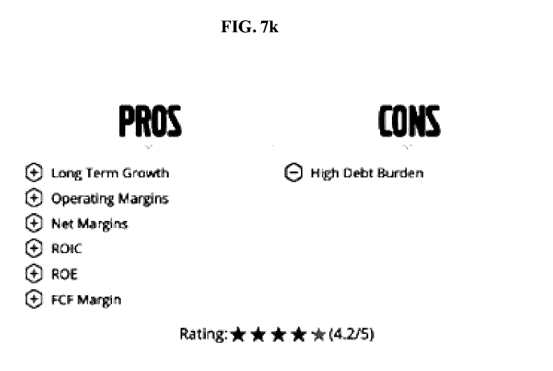

FIGS. 7a-7k depict example screenshots of a generated video for financial data of an organization. In the example herein, the media analysis module 101 has considered Apple as the organization of interest. The media comprises of information such as stock market updates (as depicted in FIG. 7a), graphs of quarterly net profits (as depicted in FIG. 7b), a rating assigned to the organization (as depicted in FIG. 7c), change in revenue (as depicted in FIG. 7d), long term growth (as depicted in FIG. 7e), operating profit/loss (as depicted in FIG. 7f), debt/equity ratios (as depicted in FIG. 7g), cash flows (as depicted in FIG. 7h), dividend yield (as depicted in FIG. 7i), other metrics such as return on invested capital, return on equity, free cash flow margin (as depicted in FIG. 7j), and pros/cons of the organization (as depicted in FIG. 7k).

The embodiments disclosed herein can be implemented through at least one software program running on at least one hardware device and performing network management functions to control the network elements. The network elements shown in FIGS. 1 and 2 include blocks, which can be at least one of a hardware device, or a combination of hardware device and software module.

The embodiment disclosed herein describe methods and systems for analyzing and reporting information related to at least one portfolio of a user in a media format to the user. Therefore, it is understood that the scope of the protection is extended to such a program and in addition to a computer readable means having a message therein, such computer readable storage means contain program code means for implementation of one or more steps of the method, when the program runs on a server or mobile device or any suitable programmable device. The method is implemented in a preferred embodiment through or together with a software program written in e.g. Very high-speed integrated circuit Hardware Description Language (VHDL) another programming language, or implemented by one or more VHDL or several software modules being executed on at least one hardware device. The hardware device can be any kind of portable device that can be programmed. The device may also include means, which could be e.g. hardware means like e.g. an ASIC, or a combination of hardware, and software means, e.g. an ASIC and an FPGA, or at least one microprocessor and at least one memory with software modules located therein. The method embodiments described herein could be implemented partly in hardware and partly in software. Alternatively, embodiments herein may be implemented on different hardware devices, e.g. using a plurality of CPUs.

The foregoing description of the specific embodiments will so fully reveal the general nature of the embodiments herein that others can, by applying current knowledge, readily modify and/or adapt for various applications such specific embodiments without departing from the generic concept, and, therefore, such adaptations and modifications should and are intended to be comprehended within the meaning and range of equivalents of the disclosed embodiments. It is to be understood that the phraseology or terminology employed herein is for the purpose of description and not of limitation. Therefore, while the embodiments herein have been described in terms of preferred embodiments, those skilled in the art will recognize that the embodiments herein can be practiced with modification within the spirit and scope of the embodiments as described herein.

What is claimed is:

1. A method for analyzing and reporting financial information related to at least one of at least one portfolio; and at least one organization by automatically creating at least one media, the method further comprising
comparing at least one financial ratio by a media analysis module to a corresponding industry average financial ratio;
calculating a median value for the at least one financial ratio by the media analysis module by considering the at least one financial ratio of other organizations;
determining at least one attribute from the calculated median value by the media analysis module by considering previous data;
assigning weightages to the at least one attribute by the media analysis module based on the deciles into which the at least one attribute falls;
calculating a weighted average of the at least one attribute by the media analysis module based on the assigned weightages;
deciding at least one pro and at least one con by the media analysis module by overlaying the weighted average and the at least one financial ratio with at least one rule; and
generating at least one media by the media analysis module based on data comprising of the at least one financial ratio, the calculated median value, the weighted average of the at least one attribute, and the at least one decided pro and at least one con.

2. The method, as claimed in claim 1, wherein the method comprises of calculating the at least one financial ratio by the media analysis module.

3. The method, as claimed in claim 1, wherein the method further comprises of determining at least one format of the media by the media analysis module based on the user behaviour and consumption of the media.

4. The method, as claimed in claim 1, wherein deciding the at least one pro and at least one con further comprises comparing the overlaid rule with industry average by the media analysis module.

5. The method, as claimed in claim 1, wherein the method for generating the at least one media further comprises of
converting the data into human-understandable text by the media analysis module;
converting the human-understandable text into audio by the media analysis module;
creating at least one animation and at least one graphics based on the data by the media analysis module; and
generating the media by stitching together at least one of the human understandable text, the converted audio, the at least one animation and the at least one graphics by the media analysis module.

6. An apparatus operable to analyze and report financial information related to at least one of at least one portfolio; and at least one organization by automatically creating at least one media, comprising:
a processor; and
a memory device, operatively connected to the processor, and having stored thereon instructions that, when executed by the processor, cause the processor to compare at least one financial ratio to a corresponding industry average financial ratio;
calculate a median value for the at least one financial ratio by considering the at least one financial ratio of other organizations;
determine at least one attribute from the calculated median value by considering previous data;
assign weightages to the at least one attribute based on the deciles into which the at least one attribute falls;
calculate a weighted average of the at least one attribute based on the assigned weightages;
decide at least one pro and at least one con by overlaying the weighted average and the at least one financial ratio with at least one rule; and
generate at least one media based on data comprising of the at least one financial ratio, the calculated median value, the weighted average of the at least one attribute, and the at least one decided pro and at least one con.

7. The apparatus, as claimed in claim 6, wherein the apparatus is further operable to calculate the at least one financial ratio.

8. The apparatus, as claimed in claim 6, wherein the apparatus is further operable to determine at least one format of the media based on the user behaviour and consumption of the media.

9. The apparatus, as claimed in claim 6, wherein the apparatus is further operable to decide the at least one pro and at least one con further comprises comparing the overlaid rule with industry average.

10. The apparatus, as claimed in claim 6, wherein the apparatus is further operable to generate the at least one media by
convert the data into human-understandable text;
convert the human-understandable text into audio;
create at least one animation and at least one graphics based on the data; and
generate the media by stitching together at least one of the human understandable text, the converted audio, the at least one animation and the at least one graphics.
